(19) United States
(12) Patent Application Publication
(10) Pub. No.: US 2024/0237166 A1
(43) Pub. Date: Jul. 11, 2024

(54) MICROWAVE HEATING APPARATUS, AND METHOD FOR MANUFACTURING ALUMINUM NITRIDE BY USING SAME

(71) Applicant: Jang-youn JUNG, Cheonan-si (KR)

(72) Inventors: Jang-youn JUNG, Cheonan-si (KR); Euy-sik JEON, Cheonan-si (KR); Dong-goo SOHN, Seoul (KR); Jae-kyung KIM, Cheonan-si (KR)

(21) Appl. No.: 18/577,774

(22) PCT Filed: Feb. 26, 2021
(86) PCT No.: PCT/KR2021/002488

§ 371 Date: Jan. 9, 2024

(51) Int. Cl. H05B 6/78; C01B 21/072; F27B 7/34; H05B 6/70; F27D 99/00

(52) U.S. Cl. CPC H05B 6/78; C01B 21/0726; F27B 7/34; H05B 6/707; C01P 2002/72; C01P 2004/03; C01P 2006/20; C01P 2006/80; F27D 2099/0028

(57) ABSTRACT

A microwave heating apparatus according to the present disclosure includes a housing, a drum unit disposed rotatably on the housing and into which heating target substance and gas are introduced, and at least one heating unit heating the drum unit by applying microwaves to the drum unit. With a microwave heating apparatus and a method for manufacturing an aluminum nitride using the same of the present disclosure, an aluminum nitride may be manufactured at a lower temperature than that of conventional methods, thereby reducing manufacturing time. Additionally, a microwave heating apparatus according to the present disclosure may significantly reduce power consumption compared to an electric heating apparatus.

### CROSS-REFERENCE TO RELATED APPLICATIONS

This application is the National Phase Entry of International Application No. PCT/KR2021/002488 filed Feb. 26, 2021.

### TECHNICAL FIELD

The present disclosure relates to a microwave heating apparatus and a method for manufacturing an aluminum nitride using the same. Aluminum nitride powder having improved properties such as thermal conductivity, insulation, and dielectric constant is manufactured into an aluminum nitride having improved physical properties in a short period of time using a microwave heating apparatus, rather than a conventional heating furnace.

### BACKGROUND ART

An aluminum nitride (AlN) exhibits better thermal conductivity and electrical insulation than alumina.

Additionally, the aluminum nitride has a coefficient of thermal expansion similar to that of a silicon (Si) wafer and improved mechanical strength and, accordingly, is applied to heat sink substrates or components.

Specifically, the aluminum nitride is utilized in aluminum nitride components for semiconductor devices, metal thin film-bonded aluminum nitride substrates, heat sink substrates for LEDs, heat sink plates for high-power Si devices, substrates for compound semiconductors, substrates for laser components, and substrates for controlling power in hybrid electric vehicles.

In particular, when the aluminum nitride is used in components for semiconductor manufacturing devices, the aluminum nitride is used in heaters, electrostatic chucks, ceramic chamber components, etc., due to its improved thermal conductivity, thermal expansion, and plasma resistance.

Moreover, an aluminum nitride having a thermal conductivity of 200 W/m·K or higher is actively used as heat sink plates for laser diodes or white LEDs.

The aluminum nitride may be manufactured by various manufacturing methods such as Carbothermal Reduction-Nitridation (CNR). The CNR involves a reaction equation Al₂O₃+3C+N₂=2AlN+3CO, and occurs at temperatures between 1,600 and 1,800° C. Normally, when using the CNR to manufacture the aluminum nitride, a conventional furnace is employed. However, the conventional furnace takes a long time to heat up to a reaction temperature of 1,600 to 1,800° C. and the reaction also takes a long time to complete. This results in decreased productivity and increased manufacturing costs.

### DISCLOSURE OF THE INVENTION

### Technical Problem

Example embodiments provide a microwave heating apparatus and a method for manufacturing an aluminum nitride using the same, which are capable of manufacturing an aluminum nitride with excellent physical properties, while enhancing productivity due to fast heating and shortened reaction times.

### Technical Solution

A microwave heating apparatus according to an example embodiment of the present disclosure includes a housing, a drum unit disposed rotatably on the housing and into which heating target substance and gas are introduced, and at least one heating unit heating the drum unit by applying microwaves to the drum unit.

The heating unit may comprise a magnetron generating microwaves, and a waveguide connected to the drum unit and applying microwaves generated by the magnetron into the drum unit.

The drum unit may comprise a tube having a reaction space into which the heating target substance and the gas are introduced, and heated by the microwaves, an insulating material surrounding an external side surface of the tube, and a shaft disposed on each side of the tube in a length direction and supported rotatably on the housing.

The shaft may comprise a feed shaft connected to one side of the tube in the length direction, having a feed flow path formed therein to introduce the gas and the heating target substance into the reaction space, and on which a temperature sensor is disposed, and an exhaust shaft connected to the other side of the tube, and having an exhaust flow path to exhaust the gas and the heating target substance from the reaction space to outside.

The drum unit may further comprise an exhaust pipe connected to the exhaust shaft and having an interior connected to the exhaust flow path.

The microwave heating apparatus may further comprise a rotation driving unit power-connected to the shaft.

The microwave heating apparatus may further comprise a body unit supporting the housing.

A method for manufacturing an aluminum nitride (AlN) using a microwave heating apparatus according to an example embodiment of the present disclosure includes preparing a mixture by mixing alumina granules and carbon powder, preprocessing of feeding the mixture to the microwave heating apparatus and supplying a gas containing nitrogen (N₂), and manufacturing an aluminum nitride.

The manufacturing the mixture may comprise mixing the alumina granules and the carbon powder at a weight ratio of 1:0.5 to 5.

The alumina granules may comprise aluminum hydroxide or alumina.

The preprocessing may comprise establishing a nitrogen atmosphere by supplying the gas containing nitrogen (N₂) at a flow rate of 5 to 20 LMP (Liters/Minute) for 10 to 60 minutes.

The manufacturing the aluminum nitride may comprise heating a temperature inside a drum unit of the microwave heating apparatus to 1,400 to 1,600° C. at a rate of 3 to 6° C. per minute, manufacturing an aluminum nitride by maintaining the temperature inside the drum unit of the microwave heating apparatus at 1,400 to 1,600° C. for 2 to 24 hours, cooling the temperature inside the drum unit of the microwave heating apparatus to 700 to 750° C., removing carbon from the aluminum nitride while maintaining the temperature inside the drum unit of the microwave heating apparatus at 700 to 750° C. for 1 to 6 hours, and recovering the aluminum nitride with the carbon removed.

The heated drum unit of the microwave heating apparatus continues to rotate at a speed of 0.1 to 2 rpm, or is repeatedly rotated or stopped in units of 1 to 120 seconds in the manufacturing aluminum nitride.

### Advantageous Effects

With a microwave heating apparatus and a method for manufacturing an aluminum nitride using the same according to the present disclosure, an aluminum nitride may be manufactured even at a low temperature to reduce manufacturing time. Additionally, a microwave heating apparatus according to the present disclosure may significantly reduce power consumption compared to an electric heating apparatus.

### BRIEF DESCRIPTION OF THE DRAWINGS

FIGS. 1 and 2 are perspective views illustrating a microwave heating apparatus according to an example embodiment of the present disclosure.

FIG. 3 is a flowchart illustrating a method for manufacturing an aluminum nitride using a microwave heating apparatus according to another example embodiment of the present disclosure.

FIG. 4 illustrates XRD analysis results of aluminum nitride according to an example embodiment of the present disclosure.

FIGS. 5A to 5C illustrate SEM images of aluminum granules before reaction according to an example embodiment of the present disclosure, and FIGS. 5D to 5F illustrate SEM images of an aluminum nitride after reaction according to an example embodiment of the present disclosure.

### BEST MODE FOR CARRYING OUT THE INVENTION

Hereinafter, example embodiments of the present disclosure will be described in more detail with reference to the accompanying drawings.

The advantages, features, and methods of achieving them of the present disclosure will become clear by referring to embodiments described in detail below with the accompanying drawings.

The present disclosure is not limited to the embodiments disclosed below, but may be implemented in various manners, and these embodiments are provided so that this disclosure will be thorough and complete, and will fully convey the scope of the present disclosure to those skilled in the art. The present disclosure is merely defined by the scope of claims.

Further, in the description of the present disclosure, when it is determined that related known technology may obscure the gist of the present disclosure, detailed description thereof is omitted.

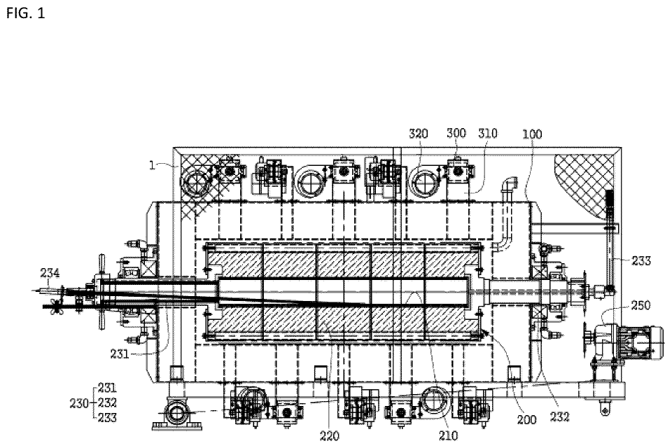

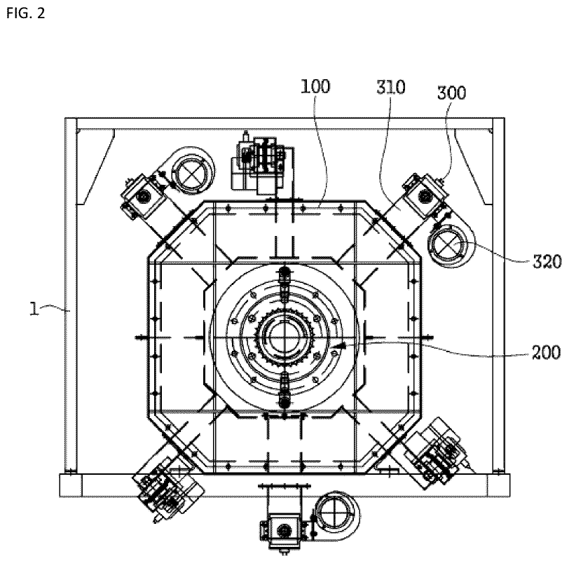

FIGS. 1 and 2 are perspective views illustrating a microwave heating apparatus according to an example embodiment of the present disclosure.

The microwave heating apparatus according to an example embodiment of the present disclosure includes a housing 100, a drum unit 200 disposed rotatably on the housing 100 and into which heating target substance and gas are introduced, and at least one heating unit 400 heating the drum unit 200 by applying microwaves to the drum unit 200.

A material of the housing 100 may include at least one selected from the group consisting of iron, stainless steel, or aluminum. A shape of the housing 100 is not limited.

Additionally, the housing 100 may serve to support or protect the drum unit 200 provided therein.

The housing 100 may further include a waveguide 310 connected to the drum unit 200 to apply microwaves, generated by a magnetron 300, to the drum unit 200.

The heating unit 400 may include a magnetron 300, generating microwaves, and a waveguide 310 connected to the drum unit 200. The waveguide 310 may apply the microwaves, generated by the magnetron 300, to the drum unit 200.

That is, the waveguide 310 may serve to apply the microwaves, generated by the magnetron 300, to the drum unit 200.

The magnetron 300 is not limited as long as it is capable of generating and transmitting microwaves to the drum unit 200 when a predetermined voltage is applied.

The drum unit 200 includes a tube 210, an insulating material 220 and a shaft 230. The tube 210 has a reaction space into which the heating target substance and the gas are introduced, and heated by the microwaves. The insulating material 220 surrounds outer surface of the tube 210. The shaft 230 is disposed on each side of the tube 210 in a longitudinal direction, and supported rotatably on the housing 100.

The tube 210 may be formed of a ceramic material, and may be hollow. In addition, a shape of the tube 210 is not limited.

A coating layer, not illustrated, may be formed on each of an internal side surface and an external side surface of the tube 210, but example embodiments are not limited thereto.

The coating layer, not illustrated, may be formed to prevent decomposition of the tube 210, but example embodiments are not limited thereto.

The tube 210 is heated by the microwaves introduced into the housing 100. The heated tube 210 may heat the heating target substance in the reaction space.

The tube 210 may be provided with an insulating material 220 surrounding the external side surface of the tube 210 to prevent heat from being discharged to the outside.

The insulating material 220 may include a material allowing microwaves to pass therethrough and preventing heat from being radiated to the outside. Therefore, the microwaves generated by the magnetron 300 may pass through the insulating material 220 to heat the tube 210. The heated tube 210 may heat the heating target substance in the reaction space.

The shaft 230 may be disposed on opposite sides of the tube 210 in a length direction, and may be supported on the housing 100 such that the drum unit 200 inside the housing 100 is capable of rotating.

Additionally, the shaft 230 includes the feed shaft 231 and an exhaust shaft 232. The feed shaft 231 is connected to one side of the tube 210 in the longitudinal direction and has a feed flow path formed therein to feed the gas and the heating target substance into the reaction space. A temperature sensor 234 is disposed on the feed shaft 231. The exhaust shaft 232 is connected to the other side of the tube 210 and has an exhaust flow path to exhaust the gas and the heating target substance from the reaction space to the outside.

The temperature sensor 234 may detect a temperature of the heating target substance. The temperature sensor 234 may be attached to the feed shaft 231 to detect the temperature of the heating target substance. Heating temperature and heating time may be adjusted by a control device (not illustrated) installed additionally.

The temperature sensor 234 may measure a temperature inside the drum unit 200. The temperature sensor 234 is not limited as long as it is capable of measuring a temperature ranging from 200 to 2,500° C.

The feed flow path and the exhaust flow path are not limited in terms of shapes.

The feed flow path may introduce the heating target substance into the drum unit 200, for example, the tube 210. The feed flow path may further include a roller, or the like, automatically driving and transporting the heating target substance.

The drum unit 200 may further include an exhaust pipe 233 connected to the exhaust shaft 232 and having an interior connected to the exhaust flow path.

The drum unit 200 may be provided with a rotation driving unit 250, which is power-connected to the shaft 230.

The drum unit 200 may be formed of a metal material such as iron, stainless steel, aluminum, or the like. The drum unit 200 may be manufactured to have any desired shape such as rectangle, hexagon, or circle, and form or size of any shape is not limited.

The microwave heating apparatus further includes a body unit 1 supporting the housing 100.

The microwave heating apparatus further includes a blower 320 connected to the magnetron 300.

In the present disclosure, the heating target substance may operate at the same time as it is fed. The microwaves generated from the magnetron 300 may be applied to the drum unit 200 through the waveguide 310. As a result, the tube 210 may absorb microwaves to generate heat. The generated heat may be transferred to the inside of the tube 210, and the heating target substance may be heated by the transferred heat.

Furthermore, when a temperature of the heating target substance reaches a certain temperature, output of the microwaves may be reduced to be maintained at a constant temperature by the control device (not shown).

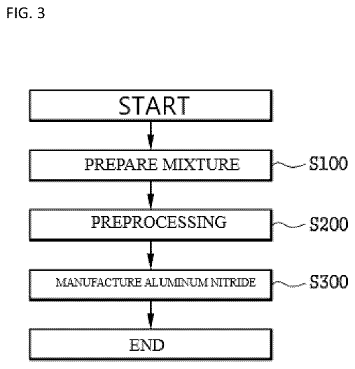

Hereinafter, a method for manufacturing aluminum nitride using a microwave heating apparatus according to an example embodiment of the present disclosure will be described in detail with reference to FIG. 3.

A method for manufacturing an aluminum nitride using a microwave heating apparatus according to another example embodiment of the present disclosure may include preparing operation S100 in which a mixture is prepared by mixing alumina granules and carbon powder, preprocessing operation S200 in which the mixture is fed to the microwave heating apparatus and a gas containing nitrogen (N₂) is supplied, and a manufacturing operation S300 in which an aluminum nitride is manufactured.

In the preparing operation S100, the alumina granules and the carbon powder may be mixed at a weight ratio of 1:0.5 to 5, preferably 1:1.

Additionally, the alumina granules may include aluminum hydroxide or alumina.

In the preprocessing operation S200, a nitrogen atmosphere may be established by supplying the gas containing nitrogen (N₂) at a flow rate of 5 to 20 LMP (Liters/Minute) for 10 to 60 minutes.

The preprocessing operation S200 may be a preparing operation before an aluminum nitride is manufactured, and may be an operation in which air occupying a reaction space is discharged and a nitrogen atmosphere is established in the reaction space.

Additionally, the gas containing nitrogen may continuously supply nitrogen gas at a flow rate of 5 to 20 LMP (Liters/Minute) to maintain a nitrogen atmosphere in the reaction space.

The nitrogen gas may have a purity of 95% or more.

After the preprocessing operation, the manufacturing operation S300 of manufacturing an aluminum nitride using the microwave heating apparatus may further include heating a temperature inside the drum unit 200 of the microwave heating apparatus to 1,400 to 1,600° ° C. at a rate of 3 to 6° C./min, manufacturing an aluminum nitride by maintaining the temperature inside the drum unit 200 of the microwave heating apparatus at 1,400 to 1,600° ° C. for 2 to 24 hours, cooling the temperature inside the drum unit 200 of the microwave heating apparatus to 700 to 750° C., removing carbon from the aluminum nitride while maintaining the temperature inside the drum 200 of the microwave heating apparatus at 700 to 750° ° C. for 1 to 6 hours, and recovering the aluminum nitride with the carbon removed.

Additionally, in the removing the carbon from the aluminum nitride while maintaining the temperature inside the drum unit 200 of the microwave heating apparatus at 700 to 750° C., supply of the gas containing nitrogen may be blocked.

In the manufacturing process in which the aluminum nitride is manufactured, the heated drum unit 200 of the microwave heating apparatus may continue to rotate at a speed of 0.1 to 2 rpm, or may be repeatedly rotated or stopped in units of 1 to 120 seconds. In this case, it is also natural that the rotation in units of 1 minute is at a speed of 0.1 to 2 rpm.

This is because rotation of the microwave heating apparatus leads to an increase in time available for the mixture to react with nitrogen, and thus reaction time may be reduced.

Hereinafter, the present disclosure will be described in greater detail by means of examples and experimental examples. However, the following examples and experimental examples are for the purpose of exemplifying the present disclosure, and the scope of the present disclosure is not limited to these examples alone.

### Example

Aluminum granules and carbon (C) powder were mixed in a 1:1 weight ratio, and aluminum nitride was manufactured according to Table 1 below using the microwave heating apparatus described above. The microwave power of the microwave heating apparatus was applied at 10 to 30 KW/m.

TABLE 1

| STEP | Holding Time | Temperature | Remark |
|---|---|---|---|
| 1 | 0.5 h | 25° C. | Feeding N₂ Gas at |
| | | | Flow Rate of 15 LPM (Liter/Min) |
| 2 | 5 h | 1,350° C. | Maintaining N₂ Gas at |
| | | | Heating Rate of 4.5° C./min |
| 3 | 12 h | 1,350° C. | Maintaining N₂ Gas at |
| | | | Rotation Speed of 1 rpm |
| 4 | — | about 720° C. | Maintaining N₂ Gas in |
| | | | Natural Cooling |
| 5 | 2 h | about 720° C. | Blocking Carbon-Removed N₂ Gas & |
| | | | Feeding Air |
| 6 | — | 25° C. | Natural Cooling |

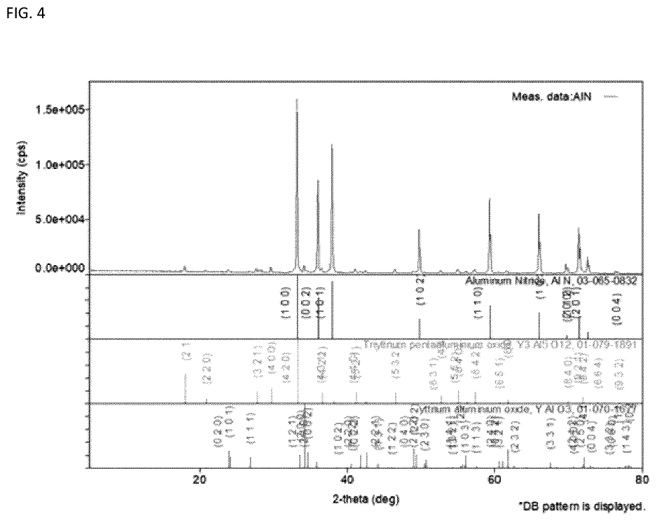

Aluminum nitride manufactured according to Example 1 was analyzed by X-Ray Diffraction (XRD). The results were presented in FIG. 4 and Table 2.

TABLE 2
Quantitative Analysis Results (WPPF)

| Phase Name | Content (%) |
|---|---|
| Aluminum Nitride | 93.3(4) |
| Triyttrium Pentaaluminium | 4.65(9) |
| Yttrium Aluminium Oxide | 1.93(6) |

From FIG. 4, it can be seen that aluminum nitride was manufactured at the peaks of (110) and (201). Also, it can be seen that 6 to 10% of yttria or calcium oxide used as a catalyst was contained.

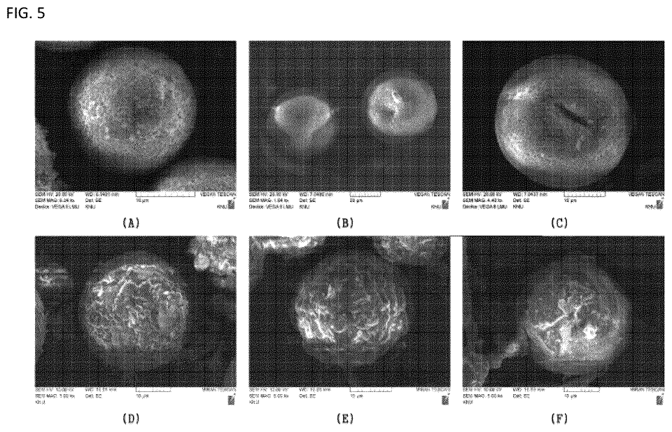

FIGS. 5A to 5C illustrate SEM images of aluminum granules before reaction according to an example embodiment of the present disclosure, and FIGS. 5D to 5F illustrate SEM images of an aluminum nitride after reaction according to an example embodiment of the present disclosure.

From FIG. 5, it can be seen that excellent aluminum nitride was synthesized through the microwave heating apparatus.

While the present disclosure has been described in detail with reference to example embodiments thereof, it should be construed that the scope of the present disclosure is not limited to a specific embodiment and is defined by the appended claims. Further, it should be understood that many alterations and modifications can be devised by those skilled in the art without departing from the scope of the present disclosure.

1. A microwave heating apparatus, comprising:
a housing:
a drum unit disposed rotatably on the housing and into which heating target substance and gas are introduced; and
at least one heating unit heating the drum unit by applying microwaves to the drum unit.

2. The microwave heating apparatus of claim 1, wherein the heating unit comprises:
a magnetron generating microwaves; and
a waveguide connected to the drum unit and applying microwaves generated by the magnetron into the drum unit.

3. The microwave heating apparatus of claim 1, wherein the drum unit comprises:
a tube having a reaction space into which the heating target substance and the gas are introduced, and heated by the microwaves;
an insulating material surrounding an external side surface of the tube; and
a shaft disposed on each side of the tube in a length direction and supported rotatably on the housing.

4. The microwave heating apparatus of claim 3, wherein the shaft comprises:
a feed shaft connected to one side of the tube in the length direction, having a feed flow path formed therein to introduce the gas and the heating target substance into the reaction space, and on which a temperature sensor is disposed; and
an exhaust shaft connected to the other side of the tube, and having an exhaust flow path to exhaust the gas and the heating target substance from the reaction space to outside.

5. The microwave heating apparatus of claim 4, wherein the drum unit further comprises an exhaust pipe connected to the exhaust shaft and having an interior connected to the exhaust flow path.

6. The microwave heating apparatus of claim 3, further comprising:
a rotation driving unit power-connected to the shaft.

7. The microwave heating apparatus of claim 1, further comprising:
a body unit supporting the housing.

8. A method for manufacturing an aluminum nitride using a microwave heating apparatus, the method comprising:
preparing a mixture by mixing alumina granules and carbon powder;
preprocessing of feeding the mixture to the microwave heating apparatus of claim 1 and supplying a gas containing nitrogen (N₂); and
manufacturing an aluminum nitride.

9. The method of claim 8, wherein the manufacturing the mixture comprises mixing the alumina granules and the carbon powder at a weight ratio of 1:0.5 to 5.

10. The method of claim 8, wherein the alumina granules comprise aluminum hydroxide or alumina.

11. The method of claim 8, wherein the preprocessing comprises establishing a nitrogen atmosphere by supplying the gas containing nitrogen (N₂) at a flow rate of 5 to 20 LMP (Liters/Minute) for 10 to 60 minutes.

12. The method of claim 8, wherein the manufacturing the aluminum nitride comprising:
heating a temperature inside a drum unit of the microwave heating apparatus to 1,400 to 1,600° C. at a rate of 3 to 6° C. per minute;
manufacturing an aluminum nitride by maintaining the temperature inside the drum unit of the microwave heating apparatus at 1,400 to 1,600° C. for 2 to 24 hours;
cooling the temperature inside the drum unit of the microwave heating apparatus to 700 to 750° C.;
removing carbon from the aluminum nitride while maintaining the temperature inside the drum unit of the microwave heating apparatus at 700 to 750° C. for 1 to 6 hours; and
recovering the aluminum nitride with the carbon removed.

13. The method of claim 8, wherein the heated drum unit of the microwave heating apparatus continues to rotate at a speed of 0.1 to 2 rpm, or is repeatedly rotated or stopped in units of 1 to 120 seconds in the manufacturing aluminum nitride.
